(19) United States
(12) Patent Application Publication
(10) Pub. No.: US 2006/0132842 A1
(43) Pub. Date: Jun. 22, 2006

(54) Image processing apparatus, method and computer program for selectively processing images

(76) Inventor: Manabu Nakamura, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/282,615

(22) Filed: Nov. 21, 2005

(30) Foreign Application Priority Data
Nov. 19, 2004 (JP) 2004-336731
Nov. 10, 2005 (JP) 2005-326070

(51) Int. Cl. G06F 3/12

(52) U.S. Cl. 358/1.15

(57) ABSTRACT

An image processing apparatus that includes a plurality of local interfaces, each local interface receiving the image data; a setting unit that stores processing information for each local interface, the processing information being indicative of whether the image data received by each local interface is allowed to be processed; and a controlling part that receives first local interface information when a processing job is sent to a first local interface of the plurality of interfaces, compares the first local interface information with the processing information stored in the setting unit, determines whether the image data received at the first local interface is allowed to be processed, adds to the received image data certification information indicative of the determination that the received image data is allowed to be processed, and enables processing of the image data received at the first local interface when the certification information is detected.

### CROSS-REFERENCE TO RELATED APPLICATIONS

The present application is based on Japanese Patent Applications No. 2004-336731, filed on Nov. 19, 2004, and No. 2005-326070, filed on Nov. 10, 2005, the entire contents of which are hereby incorporated by reference.

### BACKGROUND OF THE INVENTION

1. Field of the Invention

The present invention generally relates to an image processing apparatus, for example a printer, a method for processing image data, and a computer program that certify a processing job from a computer without a printer driver and/or a computer not connected through a network to the image processing apparatus.

1. Description on the Related Art

In order to prevent leakage of personal information or company information when exchanging information between a computer and a printer for example, it has been proposed printers provided with security functions that certify users or printer jobs (in the following, called simply “certification”) when the printers print documents.

As a method of certifying a printer, it has been proposed using functions of a printer driver that is provided by a manufacturer of the printer on a PC (personal computer) side. The printer driver sends print data to the printer after adding the certifying information to the print data. For example, the certifying information is generated when the user of the computer logs into the network. Then the printer that receives the print data determines whether the printer permits printing of a document that includes the print data, based on certifying information already stored in the printer. (Refer to Japanese Laid-Open Patent Application No. 2002-063008, for example.)

However, some computers send the print data to a printer and that computers do not have printer drivers. Thus, the certifying information cannot be added to the print data sent to the printer. For example, host computer operation systems (such as UNIX) printing with POSTSCRIPT or the like do not use printer drivers, and therefore the certification is not possible by the printer drivers.

For example, in the case that the certification by the printer drivers is used in an environment where both PCs with printer drivers and computers without printer drivers are connected to a network, every computer without the printer driver is unable to print because the certifying information is unavailable.

In order to print from the computer without the printer driver, it is necessary to disable the certification process of all the printer jobs at the printers connected to the above discussed network. However, in that case, it is impossible to maintain the security of the information because every computer or user in the network can print on the printers (no certification is required).

Therefore, a method for printing that overcomes the above problems has been proposed. More specifically, the proposed method initially registers IP addresses of the computers without printer drivers that are permitted to print in the network in the case that PCs and computers without printer drivers are connected to the network. According to this method, it is possible to certificate printer instructions from a PC with the printer driver and to certify printer instructions from a computer without the printer driver by certifying the latter based on a corresponding IP address.

However, though certification based on IP addresses is effective in a network using IP addresses, in the case that a printer and/or a computer without a printer driver are connected to a printer locally without an IP address, the method fails to certify the job from the computer because the IP address of that computer cannot be obtained. That is, in the case of the printer and the computer without the printer driver connected to each other via local interfaces such as CENTRONICS and/or USB, the certification of the printer job from the computer is not possible because of the lack of IP address, and thus the computer cannot print to the printer. On the other hand, if the certification of the printer job is disabled, every user can print.

### SUMMARY OF THE INVENTION

According to one aspect of the present invention, an image processing apparatus, a method for processing images, and a computer program are provided such that the above-mentioned problems are eliminated.

According to another aspect of the present invention, an image processing apparatus includes a plurality of local interfaces, each local interface receiving the image data; a setting unit that stores processing information for each local interface, the processing information being indicative of whether the image data received by each local interface is allowed to be processed; and a controlling part that receives first local interface information when a processing job is sent to a first local interface of the plurality of interfaces, compares the first local interface information with the processing information stored in the setting unit, determines whether the image data received at the first local interface is allowed to be processed, adds to the received image data certification information indicative of the determination that the received image data is allowed to be processed, and enables processing of the image data received at the first local interface when the certification information is detected.

According to another aspect of the present invention, a method for processing image data with an image processing apparatus includes, receiving the image data at a first local interface of a plurality of local interfaces; determining whether the image data received at the first local interface is allowed to be processed; adding certification information to the image data when the received image data is determined to be allowed to be processed in the determining step; and processing the received image data when the certification information is detected.

According to still another aspect of the present invention, a computer program product is provided for storing instructions for execution on a computer system, which when executed by the computer system, causes the computer system to perform: instructions for receiving the image data at a first local interface of a plurality of local interfaces; instructions for determining whether the image data received at the first local interface is allowed to be processed; instructions for adding certification information to the image data when the received image data is determined to be allowed to be processed in the determining step; and instructions for processing the received image data when the certification information is detected.

### BRIEF DESCRIPTION OF THE DRAWINGS

In the following, embodiments of the present invention will be described with reference to the accompanying drawings. A more complete appreciation of the present invention and many of the attendant advantages thereof will be readily obtained as the same become better understood by reference to the following detailed description when considered in connection with the accompanying drawings, wherein:

FIG. 1 is a diagram showing an example of a configuration of a printing system according to one embodiment of the present invention;

FIG. 2 is a bloc diagram showing a hardware configuration of a printer;

FIG. 3 is a fimction bloc diagram of the printer;

FIG. 4 is a flowchart showing a printing process by the printer based on a result of a determination of a certification exclusion;

FIG. 5 is a diagram showing a printer job;

FIG. 6 is a diagram showing an example of the certification exclusion information stored in an NVRAM;

FIG. 7 is an example of a setting screen for setting the certification exclusion information;

FIG. 8 is a flowchart showing a determination process where ncsd determines whether certification exclusion is on or not based on the certification exclusion information;

and

FIG. 9 is a flowchart showing a certification process where a printer application certificates the printer job.

### DESCRIPTION OF THE PREFERRED EMBODIMENTS6

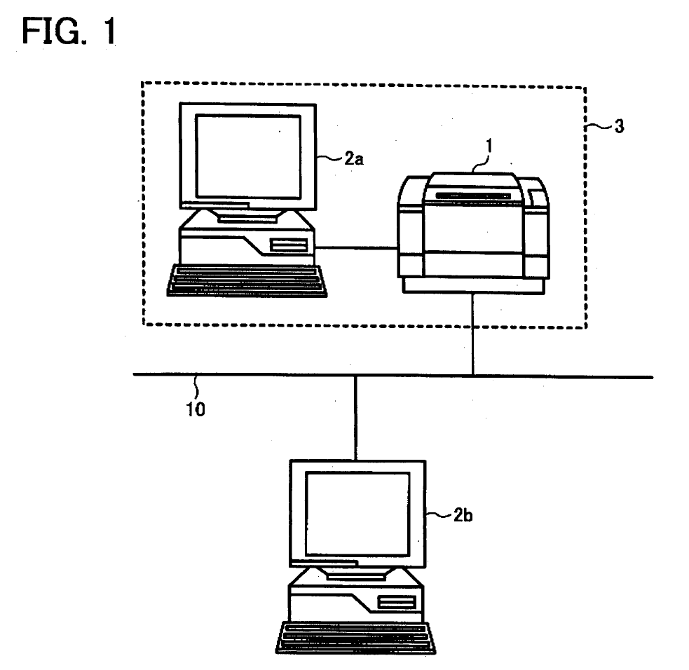

Referring now to the drawings, wherein like reference numerals designate identical or corresponding parts throughout the several views, and more particularly to FIG. 1 thereof, FIG. 1 is a diagram showing an example of a configuration of a printing system according to one embodiment of the present invention. In FIG. 1, the printing system includes a printer 1 and a print client 2a, which are connected directly to each other. It is noted that device 1 is a printer in FIG. 1 for the sake of illustration but similar image processing devices can be used as well. Thus, the print client 2a may not have a printer driver and/or an IP address and a certification of a print job sent by the print client 2a to the printer 1 cannot be realized based on the IP address and/or certification information provided by the printer driver. For the sake of simplicity, the IP address term will be used from now on meaning not only the IP address as such but also any identifier in the network that is provided by the printer driver.

The printer 1 and the print client 2a are connected to each other via a local interface, for example CENTRONICS, USB (universal serial bus), BLUETOOTH, IEEE1394 or the like. The interface can be either a wired or wireless port. The term “locally connected” is understood in the context of this specification as connected directly to each other without a network between the two objects connected to each other. A local interface means an interface connected locally between the printer and the print client.

Another print client 2b is connected to the printer 1 via a network 10 such as LAN (local area network), intranet or Internet or any other network known by one of ordinary skill in the art. The print client 2b includes a printer driver that is capable of adding certifying information to a print job to be printed to the printer 1.

The printer 1 performs printing of documents or sending facsimiles according to requests from the print clients 2a and 2b. The printer 1 may be a facsimile, a copier, or an MFPs (multi function printer) provided with the functions of a printer or the like.

Additionally, the printer 1 is capable of sending web pages showing information requested in HTTP (Hyper Text Transfer Protocol) requests according to the HTTP requests from the print client 2b. Alternatively, the printer 1 is capable of sending information regarding the setting of various local interfaces of the printer, and through an operational panel (to be described below) is capable of changing the above settings.

Moreover, the print clients 2a and 2b may be a print client such as a PC (personal computer) used by a user, a PDA (personal digital (data) assistant) or a cell phone, or any other similar device capable of sending information. The print client 2b is provided with a web browser capability displaying web pages sent from the printer 1.

The printing system according to one embodiment of the present invention realizes a secure printing operation when the print client 2a prints without a printer driver and the print data sent by the print client 2a to the printer 1 requires a secure mode printing. Therefore, the print client 2a is at least a computer that prints without a printer driver, for example, a computer with a host computer OS such as UNIX, and the like.

The printer 1 receives a printer job from the print clients 2a and 2b, and determines whether a certification of the printer job is required or not. Then the printer 1 prints according to the result of the determination. Here, the certification of the printer job includes a determination of whether printing of the printer job is permitted or not. Additionally, in this embodiment, to require the certification is called certification object and to exempt certification is called certification exclusion.

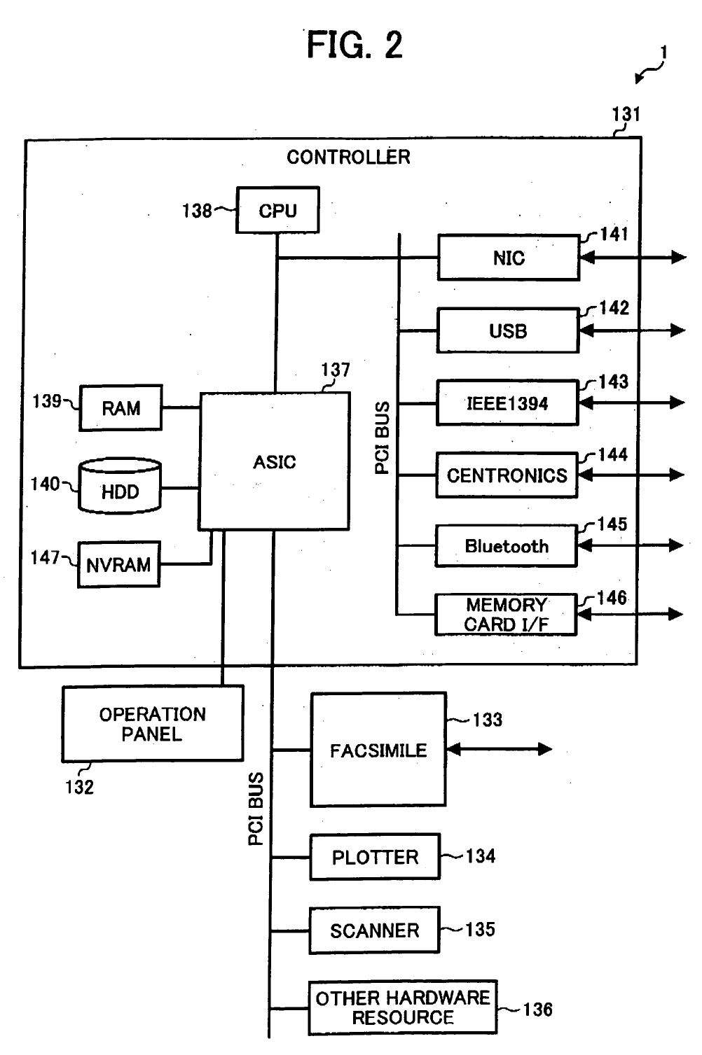

In the following, the case that the print client 2a sends a print instruction to the printer 1 and the printer 1 is set up to in the secure mode will be described. FIG. 2 is a bloc diagram showing a hardware configuration of the printer 1 according to this embodiment. In FIG. 2, the printer 1 is provided with a controller 131 that controls the printer, an operation panel 132, a facsimile 133, a plotter 134, a scanner 135, and other hardware resources 136.

In the controller 131, a general purpose CPU 138 is connected with an ASIC 137 for an image processing purpose via a PCI bus. To the PCI bus, a NIC 141 controlling network transmission, a USB port 142 providing with an USB interface, an IEEE1394 port 143 providing with an IEEE1394 interface, a Centronics port 144 providing with a CENTRONICS interface, a Bluetooth port 145 providing with a BLUETOOTH interface, and a memory card interface 146 transmits programs and data to memory cards such as an SD CARD storing option application or the like. Further, the CPU 138 is connected to the ASIC 137, and the ASIC 137 is connected to a RAM 139 as a storing device, a HDD 140, and an NVRAM 107.

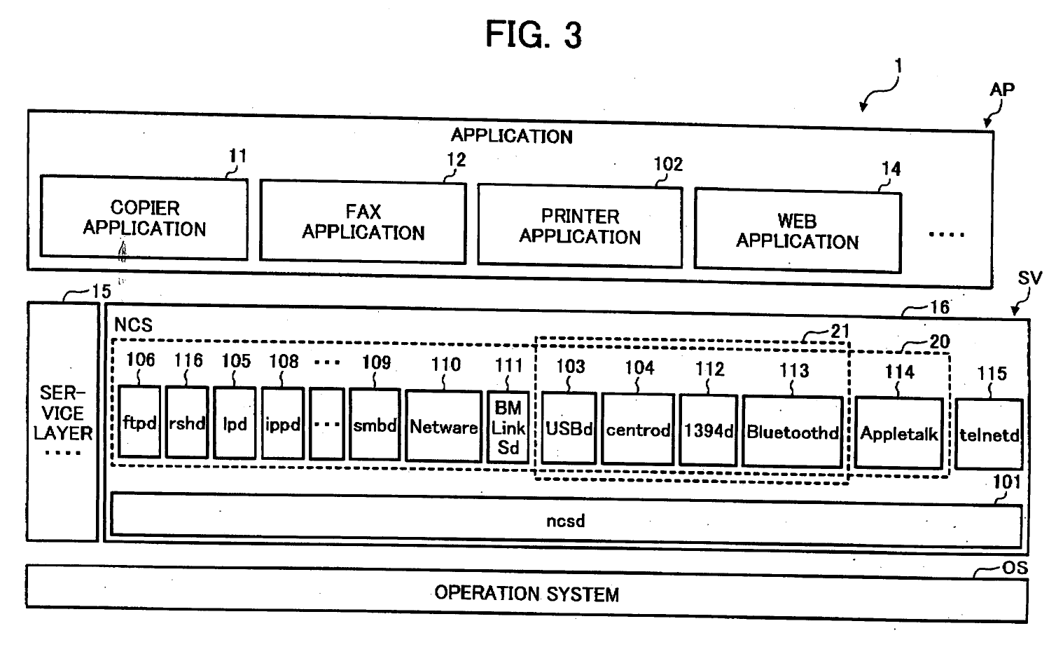

FIG. 3 is a function bloc diagram of the printer 1 according to one embodiment of the present invention. In FIG. 3, the printer 1 is provided with an application layer AP, a service layer SV and an operating system OS. An engine that actually forms images or the like is omitted.

The application layer AP includes a plurality of software programs that perform certain processes in the printer 1 and is provided with a copier application 11 that conducts processes concerning a copier, a FAX application 12 that conducts processes concerning a facsimile, a printer application 102 that conducts processes concerning a printer and a web application 14 that conducts processes concerning a web browsing.

The service layer SV includes a plurality of software programs that offer service functions to the above noted applications in the application layer AP. The service layer in FIG. 3 is provided with NCS (network control service) 16 and other services 15.

The NCS 16 is provided with ncsd (network control service daemon) 101 that interfaces between daemons providing with various services and the operating system OS. The ncsd 101 is a daemon that is resident in the RAM 139 or the like after the printer 1 is activated. The ncsd 101 controls print daemons 20 as described below.

The daemons in NCS 16 include the print daemons 20 and telnetd 115, which conducts processes concerning the telnet protocol. Here, the daemons that can transmit print data are collectively called print daemons 20.

The print daemons 20 are provided with ftpd (file transfer protocol daemon) 106 that conducts processes concerning FTP, rshd (remote shell daemon) 116 that conducts processes to perform remote commands, lpd (local printer daemon) 105 for users to use printers connected locally, ippd (internet printing protocol daemon) 108 that conducts processes concerning IPP, smbd daemon 109 that offers file sharing service and printing service to WINDOWS clients, Netware daemon 109 that processes files convertible to NETWARE, BMLinkSd 111 that conducts processes concerning BMLINKS, USBd 103 that processes print instructions from computers connected via USB, centrod 104 that processes print instructions from computers connected via CENTRONICS, 1394d 112 that processes print instructions from computers connected via IEEE1394, Bluetoothd 113 that processes print instructions from computers connected via BLUETOOTH, and Appletalk 114 that conducts processes concerning APPLETALK protocol or the like.

In this embodiment, the local print daemon 21 includes the print daemons 20, USBd 103, centrod 104, 1394d 112 and Bluetoothd 113 and performs printing when the printer 1 and the print client 2a are connected locally to each other.

Additionally, the other services 15 are, for example, ECS (engine control service) provided with functions such as to control an engine part, MCS (memory control service) provided with functions such as to control memories and OCS (operation panel control service) provided with functions such as to control an operation panel that is an interface with an operator.

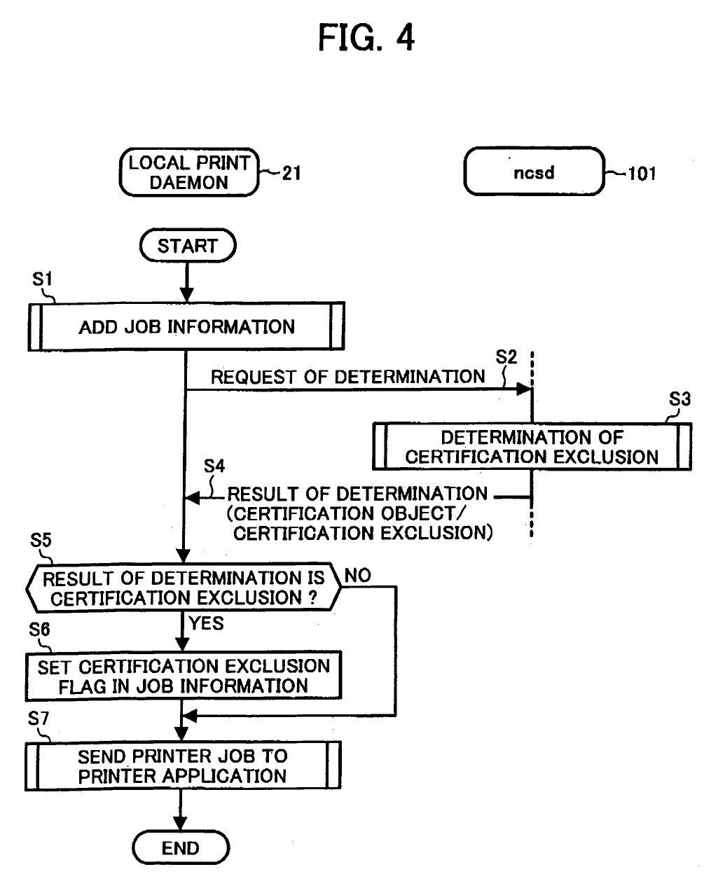

Based on the configuration described above, a printing process conducted by the printer 1 according to a result of whether the certification exclusion is on or off, is explained regarding to a flowchart as shown in FIG. 4. In the flowchart of FIG. 4, the left side indicates a process by a local print daemon 21 and the right side indicates a process by ncsd 101. The process in FIG. 4 starts when the printer 1 receives print data from the print client 2a locally connected to the printer 1. That is, the local print daemon 21 receives print data via a local interface such as USB 140 for example. Other interfaces are possible as well.

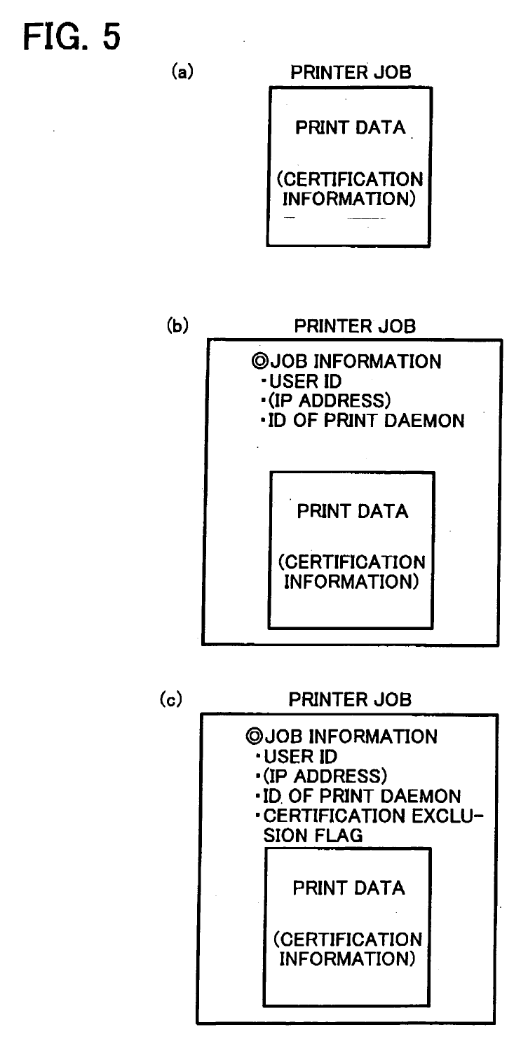

FIG. 5 is a diagram showing a printer job generated by the print client 2a to job information was added by the local print daemon 21. The local print daemon 21 receives the print data shown in FIG. 5(a). The print data generated by a PC with a printer driver contain certification information. However, the print data generated by a PC without a printer driver do not contain certification information.

The local print daemon 21 adds job information to the received print data (S1). The job information is additional information, other than the print data, such as a user ID of a user who gives a print instruction, an IP address of the print client 2a (in the case that the print client has such an address), and an ID of the print daemon 20. The ID of the print daemon 20 identifies the specific print daemon, for example centrod 104 or USBd 103. FIG. 5(b) shows an example of the job information that is added to the print data. The job information is added to the print data by the local print daemon 21. Additionally, the IP address of the print client 2a is not obtained when the printer 1 and the print client 2a are locally connected to each other.

Then, the local print daemon 21 requests the ncsd 101 to determine the status of the certification mode (S2), i.e., whether certification is required to print at printer 1. Though the determination of the certification mode will be described in detail below, the determination of the certification mode determines whether a setting of the certification mode of the local print daemon (in this embodiment, one of USBd 103, centrod 104, 1394d 112 and Bluetoothd 113) is on or off.

The ncsd 101 performs the determination of the certification mode (certification exclusion) according to certification setting information stored in the printer, for example, the NVRAM 107 (S3). Then, the ncsd 101 sends a certification object or certification exclusion as a result of the determination of the certification mode to the local print daemon 21 (S4).

The local print daemon 21 that receives the result of the determination of the certification mode determines whether the determination result is the certification object or the certification exclusion (S5).

If the determination result of the certification mode is the certification exclusion (Yes in S5), the local print daemon 21 sets a certification exclusion flag in the job information (S6). This step makes the printer job to include the print data, the job information and the certification exclusion flag. FIG. 5(c) shows an example of the printer job that includes the certification exclusion flag in the job information. Here, the certification exclusion flag is a flag notifying the printer application 102 that the certification is not necessary for the printer job.

After the certification exclusion flag is set, the local print daemon 21 sends the printer job to the printer application 102 (S7) such that the print data is printed.

If the result of the determination in step (S5) is the certification object (No in S5), the local print daemon 21 sends the printer job to the printer application 102 without setting (adding) a certification exclusion flag (S7).

The printer application 102 that receives the printer job performs printing if the received printer job contains the certification exclusion flag. On the contrary, the printer application 102 will not perform the printing if the certification exclusion flag is missing in the printer job.

Accordingly, even in the case of a computer without a printer driver (certification by a printer driver is impossible) or an IP address, if the certification exclusion flag is on, it is possible to print to the printer 1 locally connected to the computer. In general, as discussed above, a user is certified when a user logs in as the print client 2b into the network, and therefore, security can be maintained based on that certifying.

However, according to this embodiment, a computer without a printer driver and not logged in into the network still can print to the printer without affecting the security mode for the computers connected to the network. It is noted that the present embodiment sets up specific local interfaces of the printer to allow print data from computers (without print drivers or IP addresses) to be printed without certification. This printing process without certification is achieved by adding job information and the certification exclusion flag to the print data that is sent to the printer. It is noted that a computer connected to the printer via the network can directly print without going through the steps shown in FIG. 4.

Next, a method for setting the certification exclusion information that is referred to by the ncsd 101 in order to determine the certification mode will be explained.

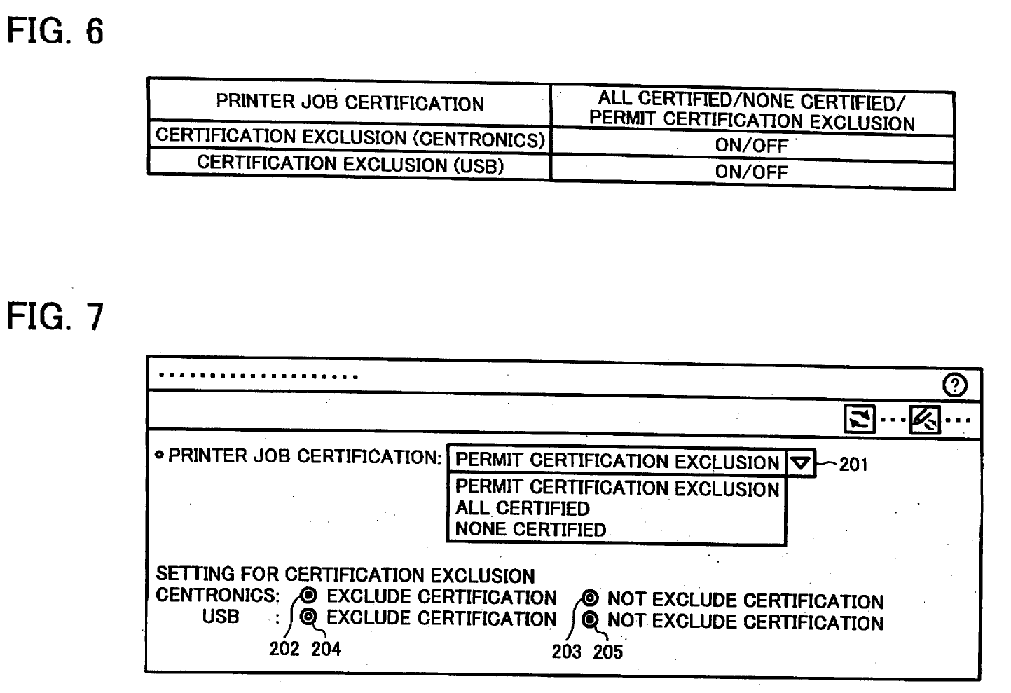

FIG. 6 is a diagram showing an example of the certification exclusion information stored in the NVRAM 107. The certification exclusion information in FIG. 6 has settings that are, for example, “printerjob certification,” “certification exclusion (CENTRONICS)” and “certification exclusion (USB).” It is noted that the certification exclusion information might have information about other local interfaces than the CENTRONICS and the USB. For the “printer job certification,” each of “all certified”/“none certified”/“permit certification exclusion” is set. In the case “all certified” is set, all printer jobs are certified regardless of a connection between the printer 1 and the print client 2a or 2b. Accordingly, in the case the “all certified” is set, all printer jobs from computers without printer drivers or IP addresses are not permitted.

In the case the “none certified” is set, all printer jobs are not certified regardless of the connection between the printer 1 and the print client 2a or 2b. Accordingly, in the case the “none certified” is set, all printer jobs even from computers without printer drivers are permitted to be printed.

In the case the “permit certification exclusion” is set, it is possible to control a setting of the certification exclusion for each local interface. The settings of the “certification exclusion (CENTRONICS)” and the “certification exclusion (USB)” become valid. For the “certification exclusion (CENTRONICS)” and the “certification exclusion (USB),” one of “ON” or “OFF” options is set. The “ON” option means that the certification exclusion is active and the “OFF” option means that the certification exclusion is disabled.

Accordingly, as shown in FIG. 6 in the case that the “certification exclusion (CENTRONICS)” is “ON” and the “certification exclusion (USB)” is “OFF,” the print data received via CENTRONICS are printed without certification, and the print data received via the USB are determined to be printed or not based on a result of the certification process described with reference to FIG. 4. Although in FIG. 6 only the settings for the CENTRONICS and USB are shown, settings for all other local interfaces of the printer 1 are set. Moreover, any combination of the local interfaces may be set to be “ON” and the remaining local interfaces may be set to be “OFF.”

Accordingly, in the case that the “permit certification exclusion” is set in the certification exclusion information, as shown in step (S4) in FIG. 4, the ncsd 101 sends the certification object or certification exclusion as a result of the determination of the certification mode to the local print daemon 21.

FIG. 7 shows an example of a setting screen for setting the certification exclusion information. The setting screen in FIG. 7 is a web page written, for example, in HTML (Hyper Text Markup Language) and displayed in a web browser that accesses the web application 14 in the printer 1. Alternatively, the setting screen may be provided by telnetd 115 for the print client 2b or the setting screen may be displayed in the operation panel 143 in order to be set by the printer itself.

In this setting screen, each one of the “all certified” and “none certified” can be selected for the “printer job certification.” In FIG. 7, the “permit certification exclusion” is selected by clicking a pull-down menu with a mouse or the like.

If the “permit certification exclusion” is selected for the “printer job certification,” settings for the “certification exclusion” below can be set. In FIG. 7, as local interfaces, CENTRONICS and USB are shown. In order to exclude the certification for the print data received via the CENTRONICS, it is necessary to select the “exclude certification” (radio button 202) and in order not to exclude the certification, it is necessary to select the “not exclude certification” (radio button 203). Similarly, to exclude the certification for the print data received via the USB, it is necessary to select the “exclude certification” (radio button 204) and in order not to exclude the certification, it is necessary to select the “not exclude certification” (radio button 205). In FIG. 7 the radio buttons 202 and 205 are selected.

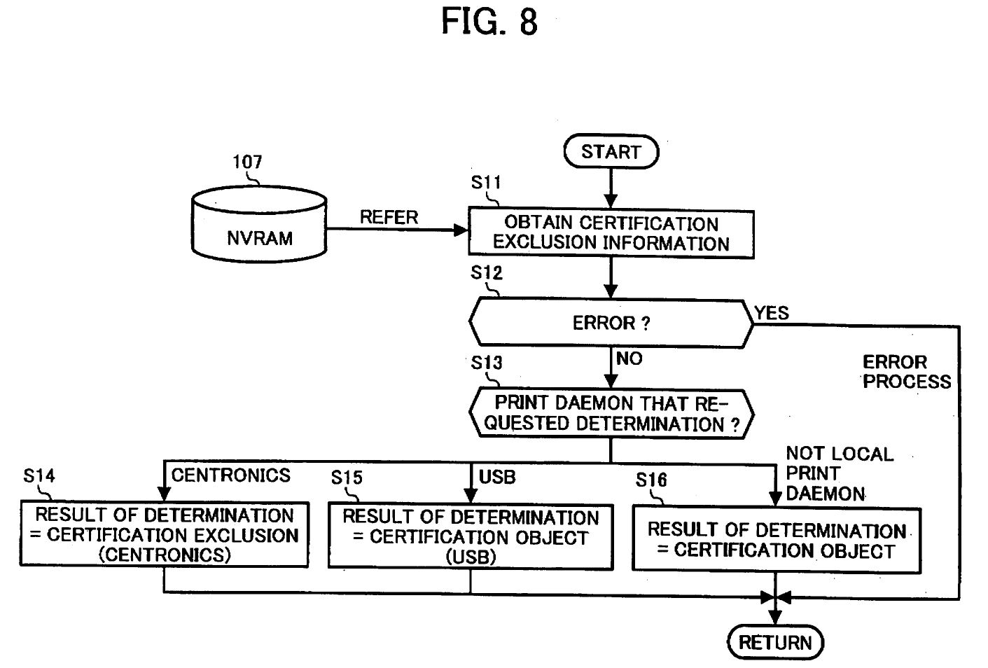

Next, a determination process of the selection mode is explained based on a flowchart shown in FIG. 8, where a determining part of the ncsd 101 determines whether the certification exclusion is on or off, based on the certification exclusion information.

After receiving a request of determination of the certification mode in step S3 in FIG. 4, the nscd 101 obtains the certification exclusion information stored in the NVRAM 107 (S11).

Then the ncsd 101 determines whether the ncsd 101 correctly received the certification exclusion information from the NVRAM 107 (S12). If the ncsd 101 did not receive correctly the certification exclusion information (Yes in S12), the process in FIG. 8 ends due to an error.

If the ncsd 101 receives correctly the certification exclusion information (No in S12), the ncsd 101 determines which print daemon 20 requested the determination of the certification exclusion (S13). That is, according to the print daemon 20 that requested the determination, the ncsd 101 determines whether the print job requires the certification exclusion or certification object referring to the certification exclusion information.

If the print daemon 20 that requested the certification determination is the centrod 104 (CENTRONICS), the ncsd 101 refers to the setting of the “certification exclusion (CENTRONICS)” in the certification exclusion information stored in the NVRAN 107. If the print daemon 20 that requested the certification determination is the USBd 103 (USB), the ncsd 101 refers to the setting of the “certification exclusion (USB)” in the certification exclusion information. The ncsd 101 determines whether the print job requires the certification exclusion or certification object according to the “ON” or “OFF” setting of the corresponding local interface (S14, S15).

Additionally, if the print daemon 20 that requested the certification is not the local print daemon 21, all printer jobs are deemed certification objects, and therefore, the result of the determination is the certification object (S16). In this case, a print instruction is not from the local print daemon 21, and therefore, the print job is certified, for example, based on the information added by the print driver of the corresponding computer. The result of the determination is sent to the local print daemon based on the process above described (S4 in FIG. 4).

Thus, based on the above explanation, the printer of the present embodiment is capable to verify, for a print job, which port of the printer received the print job. Based on the port that received the print job, the printer determines that for (1) ports connected to the network certification is required for any print job, (2) for local ports connected to a computer, the certification is or not necessary depending on information stored in the printer for each local port.

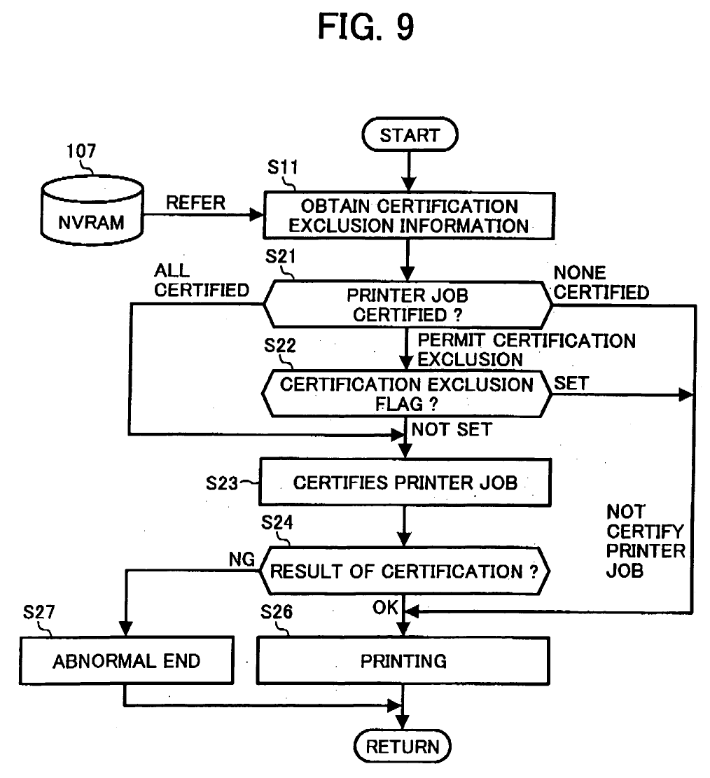

A printing certification process will be explained based on a flowchart shown in FIG. 9, where the printer application 102 certifies the printer job. A process of the flowchart in FIG. 9 corresponds to the process in step (S7) of FIG. 4. The process of the flowchart in FIG. 9 starts when the printer application 102 receives the printer job.

First, the printer application 102 obtains the certification exclusion information stored in NVRAM 107 (S11). The certification exclusion information referred to by the printer application 102 includes settings for the “printer job certification.” The printer application 102 obtains each one of the “all certified,” “none certified” or “permit certification exclusion.” Then the printer application 10 conducts the following processes according to the obtained contents of the setting for the “printer job certification.”

In case that the “all certified” is set, the printer application 102 certificates the printer job regardless of the certification exclusion flag (S23). Here, the certification is conducted based on the certification information included in the print data in order to determine whether printing of the print data by the user is permitted or not.

If the result of the certification is NG (NG in S24), the printer application 102 performs an error process (for example, displays an error message in the operation panel 143) (S27) and ends the process without printing the print data. If the result of the certification is OK (OK in S24), the printer application 102 prints the print data (S26) and ends the process.

In case that the “non certified” is set, the printer application 102 does not certifies the printer job regardless of the certification exclusion flag. Accordingly, in step S21 the printer application 102 obtains the contents of the settings for the “printer job certification,”and the printer application 102 prints the print data and ends the process (S26).

In case that the “permit certification exclusion” is set, the printer application 102 refers to the certification exclusion flag in the job information and determines whether the certification exclusion flag is set or not (S22). If the certification exclusion flag is set (certification exclusion is on), the printer application 102 prints the print data without certifying the printer job (S26) and ends the process.

If the certification exclusion flag is not set (certification exclusion is off), the printer application 102 certifies the printer job (S23). If the result of the certification is NG (NG in S24), the printer application 102 performs an error process (for example, displays an error message in the operation panel 143) (S27) and ends the process without printing. If the result of the certification is OK (OK in S24), the printer application 102 prints the print data (S26) and ends the process.

As described above, according to the printer and the method for printing of this embodiment, it is possible to print in a secure mode according to a print instruction from a computer without a print driver connected locally to the printer in an environment where both a PC and a computer without the print driver are present.

Additionally, it is possible to certify a printer job from a computer connected via a network based on certification information generated by a printer driver or based on an IP address. Accordingly, even in an environment where both a PC and a computer without the printer driver are present, regardless of the existence of a printer driver or a connection between a printer and a client, it is possible to print in the secure mode.

Moreover, a computer program according to the present invention causes a printer to function as the printer 1 described above. The computer program is executed by the computer so that the above-described effects can be obtained.

This computer program may be prestored in a storing part such as a ROM, an HDD, and the like mounted to the computer. Alternatively, the computer program may be recorded in the non-volatile recording medium (memory) such as a CD-ROM, a flexible disk, an SRAM, an EEROM, a memory card, and the like, to provide the program to the computer. By causing the computer to read out the computer program from the memory and execute the program, each of the steps described above can be conducted.

Furthermore, by connecting to a network and downloading the computer program from an external device mounted where the recording medium recording the program or an external device recording the program in a recording part, each of the steps described above can be conducted.

The present invention is not limited to the specifically disclosed embodiments, and variations and modifications may be made without departing from the scope of the present invention.

What is claimed is:

1. An image processing apparatus that processes image data, comprising:
a plurality of local interfaces, each local interface configured to receive the image data;
a setting unit configured to store processing information for each local interface, the processing information being indicative of whether the image data received by each local interface is allowed to be processed; and
a controlling part configured to receive first local interface information when a processing job is sent to a first local interface of the plurality of interfaces, compare the first local interface information with the processing information stored in the setting unit, determine whether the image data received at the first local interface is allowed to be processed, add to the received image data certification information indicative of the determination that the received image data is allowed to be processed, and enable processing of the image data received at the first local interface when the certification information is detected.

2. The image processing apparatus of claim 1, wherein the controlling part is configured to enable the processing of the image data when the image data is received from a network interface.

3. The image processing apparatus of claim 1, wherein the first local interface information is indicative of the type of the first local interface.

4. The image processing apparatus of claim 1, wherein the controlling part is configured to deny processing of the image data when determining that the received image data lacks the certification information.

5. The image processing apparatus of claim 1, wherein the plurality of local interfaces includes at least one of a USB, CENTRONICS, IEEE1394, and BLUETOOTH interface.

6. The image processing apparatus of claim 2, wherein the network interface is LAN.

7. The image processing apparatus of claim 1, wherein the setting unit includes one of a RAM, a non-volatile RAM, a ROM, and a hard disc drive.

8. The image processing apparatus of claim 1, further comprising:
an operation panel configured to input the certification information.

9. The image processing apparatus of claim 1, wherein the controlling part is further configured to enable an electronic device connected to the image processing apparatus to edit the stored processing information via a network.

10. A method for processing image data with an image processing apparatus, comprising:
receiving the image data at a first local interface of a plurality of local interfaces;
determining whether the image data received at the first local interface is allowed to be processed;
adding certification information to the image data when the received image data is determined to be allowed to be processed in the determining step; and
processing the received image data when the certification information is detected.

11. The method of claim 10, further comprising:
storing processing information regarding the plurality of local interfaces, the processing information being indicative of whether the image data received by each local interface is allowed to be processed.

12. The method of claim 11, wherein the determining further comprises:
receiving local interface information of the first local interface when the image data is received at the first local interface.

13. The method of claim 12, wherein the determining further comprises:
comparing the local interface information of the first local interface with the processing information to determine whether the image data received at the first local interface is allowed to be processed.

14. The method of claim 10, further comprising:
processing the image data after the receiving step when the image data is received from a network interface.

15. The method of claim 10, wherein the processing further comprises:
displaying an error message if the certification information is not added to the image data received at the first local interface; and
stopping the processing of the received image data.

16. The method of claim 11, wherein the local interface includes one of a USB, CENTRONICS, IEEE1394, and BLUETOOTH.

17. A computer program product storing instructions for execution on a computer system, which when executed by the computer system, causes the computer system to perform:
instructions for receiving the image data at a first local interface of a plurality of local interfaces;
instructions for determining whether the image data received at the first local interface is allowed to be processed;
instructions for adding certification information to the image data when the received image data is determined to be allowed to be processed in the determining step; and
instructions for processing the received image data when the certification information is detected.

18. The computer program of claim 17, further comprising:
instructions for storing processing information regarding the plurality of local interfaces, the processing information being indicative of whether the image data received by each local interface is allowed to be processed.

19. The computer program of claim 18, wherein the instructions for determining further comprises:
instructions for receiving local interface information of the first local interface when the image data is received at the first local interface.

20. The computer program of claim 19, wherein the instructions for determining further comprises:
instructions for comparing the local interface information of the first local interface with the processing information to determine whether the image data received at the first local interface is allowed to be processed.

21. The computer program of claim 17, further comprising:
instructions for processing the image data after the receiving step when the image data is received from a network interface.

22. The computer program of claim 17, wherein the instructions for processing further comprises:
instructions for displaying an error message if the certification information is not added to the image data received at the first local interface; and
instructions for stopping the processing of the received image data.

23. The computer program of claim 18, wherein the local interface includes one of a USB, CENTRONICS, IEEE1394, and BLUETOOTH.
